(19) United States
(12) Patent Application Publication
(10) Pub. No.: US 2007/0076129 A1
(43) Pub. Date: Apr. 5, 2007

(54) Modular liquid crystal display

(75) Inventors: Long-San Yang, Yung Ho City (TW); Ming-Shan Huang, Yung Ho City (TW); Chia-Yao Chang, Yung Ho City (TW)

Correspondence Address: BIRCH STEWART KOLASCH & BIRCH, PO BOX 747, FALLS CHURCH, VA, 22040-0747, US

(73) Assignee: Proview Electronics Co., Ltd.

(21) Appl. No.: 11/541,580

(22) Filed: Oct. 3, 2006

(30) Foreign Application Priority Data
Oct. 5, 2005 (TW) 94217248

(51) Int. Cl. H04N 5/44

(52) U.S. Cl. 348/725

(57) ABSTRACT

A modular liquid crystal display includes a front frame, a liquid crystal panel mounted to a rear side of the front frame, a module box mounted behind and electrically connected to the liquid crystal panel, and a back cover located behind the module box. The module box includes a case, a main board mounted in the case and electrically connected to the liquid crystal panel to control the liquid crystal display, and a TV signal receiving module mounted in the case and electrically connected to the main board to receive TV signals for playback on the liquid crystal display.

### RELATED APPLICATIONS

The present application is based on, and claims priority from, Taiwan Application Serial Number 94217248, filed Oct. 5, 2005, the disclosure of which is hereby incorporated by reference herein in its entirety.

### FIELD OF THE INVENTION

The present invention relates to a liquid crystal display, and more particularly, to a modular liquid crystal display.

### BACKGROUND OF THE INVENTION

A liquid crystal display (LCD) is designed with a mechanism that changes the polarization direction of an incident light to the direction in which the liquid crystal molecules are arranged. The liquid crystal display is a flat panel display and has gradually replaced the conventional cathode ray tube (CRT) display due to the advantages of occupying only a small space, having small panel thickness, low weight, and low power consumption, and free of electromagnetic wave radiation and thermal radiation.

Liquid crystal display technology has been rapidly developed in recent years. Computer systems with a liquid crystal display have a high market share. Liquid crystal televisions (TV) have also been widely and rapidly developed for home televisions. Therefore, the liquid crystal display will play a very important role in people's future life.

For the liquid crystal display to provide more functions, it necessitates mounting a large quantity of functional modules in the liquid crystal display. Conventionally, these functional modules are separately located at different positions in the liquid crystal display causing maintainence or repair difficulties. For instance, when a liquid crystal display is out of order, it must be transported from the user to a maintenance man for trouble shooting and repair. Since the liquid crystal display is bigger and bigger in size, it is not so easy to move and transport the big-size liquid crystal display. And, the maintenance man needs more time and effort to locate the damaged module from the large quantity of differently positioned functional modules.

In some countries, it is stipulated an imported liquid crystal display must have at least some locally assembled parts to meet a preferential tariff. Therefore, it is preferable the liquid crystal display is configured to allow local assembly. However, the conventional liquid crystal display has a large quantity of functional modules arranged therein. To assemble these functional modules locally would involve many complicated procedures to inevitably increase the cost of the liquid crystal display.

The liquid crystal display, particularly the liquid crystal TV, does not always include a TV signal receiving module adapted to receive a locally adopted signal form. For the liquid crystal display to receive the local signal form, it must be partially disassembled to change the TV signal receiving module to another suitable one.

Similarly, the liquid crystal display, particularly the liquid crystal TV, does not always include a power supply circuit complying with a local supply voltage, and must be disassembled to change the power supply circuit to another suitable one.

In brief, since the conventional liquid crystal display has a large quantity of separately located functional modules therein, the manufacturer must take more time and effort to change the modules to adapt the liquid crystal display for local use.

### SUMMARY OF THE INVENTION

A primary object of the present invention is to provide a liquid crystal display that includes a module box into which all functional modules in the liquid crystal display are integrated to facilitate future maintenance and repair of the liquid crystal display.

Another object of the present invention is to provide a liquid crystal display that includes a module box into which all functional modules in the liquid crystal display are integrated, so as to enable easy adaptation of the liquid crystal display to different local operation requirements simply by changing the module box to another suitable one.

A further object of the present invention is to provide a liquid crystal display that includes a module box into which all functional modules in the liquid crystal display are integrated, so that the module box and the remaining parts of the liquid crystal display may be separately produced, and then sold to and easily assembled in a foreign country to meet local regulation with respect to preferential tariffs.

A still further objective of the present invention is to provide a liquid crystal display that includes a module box into which all functional modules in the liquid crystal display are integrated, so that the liquid crystal display may be easily adapted to receive a different local TV signal form simply by changing the module box to another one having a suitable TV signal receiving module.

A still further object of the present invention is to provide a liquid crystal display that includes a module box into which all functional modules in the liquid crystal display are integrated, so that the liquid crystal display may be easily adapted for use with a different local supply voltage simply by changing the module box to another one having a suitable power supply circuit.

A still further object of the present invention is to provide a liquid crystal display that includes a module box into which all functional modules in the liquid crystal display are integrated, wherein the module box has standardized dimensions to save research and development (R&D) and mold forming costs, enable upgraded production efficiency of the liquid crystal display, and reduce problems in logistics thereof.

A still further object of the present invention is to provide a liquid crystal display that includes a module box into which all functional modules in the liquid crystal display are integrated, so that most circuits of the liquid crystal display are mounted in the module box to largely reduce the problem of electromagnetic interference.

A still further object of the present invention is to provide a liquid crystal display that includes a module box into which all functional modules in the liquid crystal display are integrated, and the module box may be managed through an identification databank built to control the inventory of spare parts and the maintenance of the liquid crystal display for the purpose of after service.

To achieve the above and other objects, the liquid crystal display according to an embodiment of the present invention includes a front frame, a liquid crystal panel mounted behind the front frame, a module box mounted behind and electrically connected to the liquid crystal panel, and a back cover located behind the module box. The module box includes a case, a main board mounted in the case and electrically connected to the liquid crystal panel to control the liquid crystal display, and a TV signal receiving module mounted in the case and electrically connected to the main board to receive TV signals for playback on the liquid crystal display.

In a preferred embodiment of the present invention, there is also a power supply circuit mounted in the module box and electrically connected to the main board to supply power to the liquid crystal display, and a back-end audio/video (AV) input/output (I/O) interface mounted in the module box and electrically connected to the main board to provide the liquid crystal display with an AV I/O function.

According to the present invention, the main board in the module box has an analog to digital (A-D) converter mounted thereon for converting a received analog TV signal into a digital signal for playback on the liquid crystal display.

The main board in the module box may also have an image decoding chip mounted thereon to control images displayed on the liquid crystal display, an interlace eliminating chip for eliminating interlaced images from the liquid crystal display, and an automatic image reducing and enlarging chip to control image reduction and enlargement on the liquid crystal display.

There are still other elements that may be applied to the modular liquid crystal display of the present invention. For example, a sound-effect processing chip may be mounted on the main board to provide the liquid crystal display with a function of producing sound effects.

In the present invention, the case for the module box is preferably made of a metal material, and most preferably an electromagnetic-shielding metal box to provide an electromagnetic shielding effect for the modular liquid crystal display.

With the liquid crystal display having all functional modules thereof integrated in a module box, a user, a maintenance man, or a manufacturer may easily adapt the liquid crystal display to different local operation requirements simply by changing the module box to another suitable one. For example, the module box may be changed to another one having a suitable TV signal receiving module for the liquid crystal display to receive a different signal form adopted by a specific place. Similarly, the manufacturer or the user may change the module box to another one having a suitable power supply circuit for the liquid crystal display to be used with a different supply voltage. A maintenance man may simply dismount an old module box to easily achieve the purpose of repairing the liquid crystal display. For some countries that stipulate an imported liquid crystal display must have at least some part of it assembled locally to meet the preferential tariff, the manufacturer may produce and export the module box and the remaining part of the liquid crystal display separately and then easily assemble them in the importing country to reduce the manufacturing cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a modular liquid crystal display according to a preferred embodiment of the present invention; and

FIG. 2 is an exploded perspective view of a preferred embodiment of a module box for the modular liquid crystal display of the present invention.

### DETAILED DESCRIPTION OF THE PREFERRED EMBODIMENTS

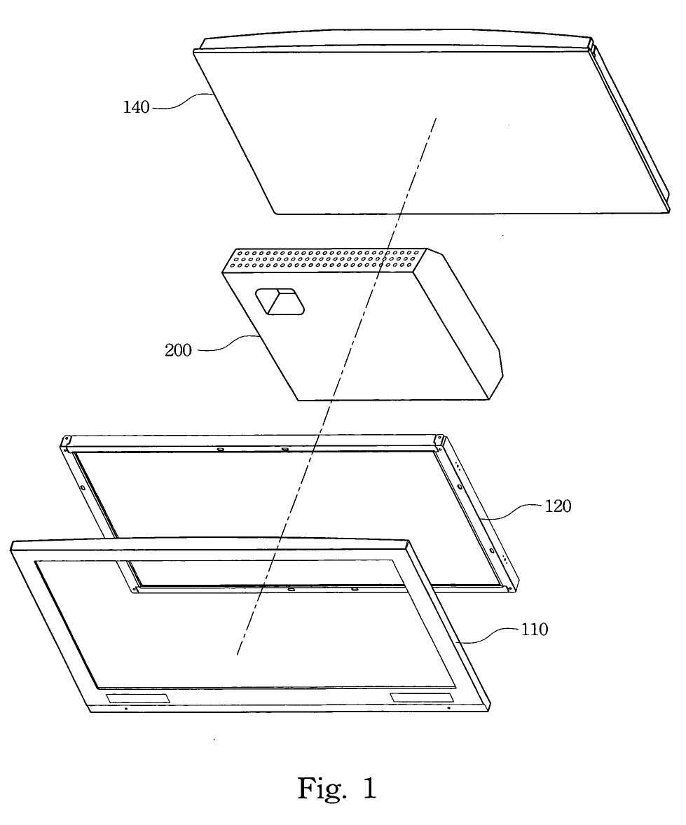

Refer to FIG. 1. FIG. 1 is an exploded perspective view of a modular liquid crystal display 100 according to a preferred embodiment of the present invention. As shown, the modular liquid crystal display 100 includes a front frame 110, a liquid crystal panel 120, a module box 200, and a back cover 140. The liquid crystal panel 120 is mounted to a rear side of the front frame 110, and the module box 200 is mounted behind and electrically connected to the liquid crystal panel 120. The back cover 140 is located behind the module box 200.

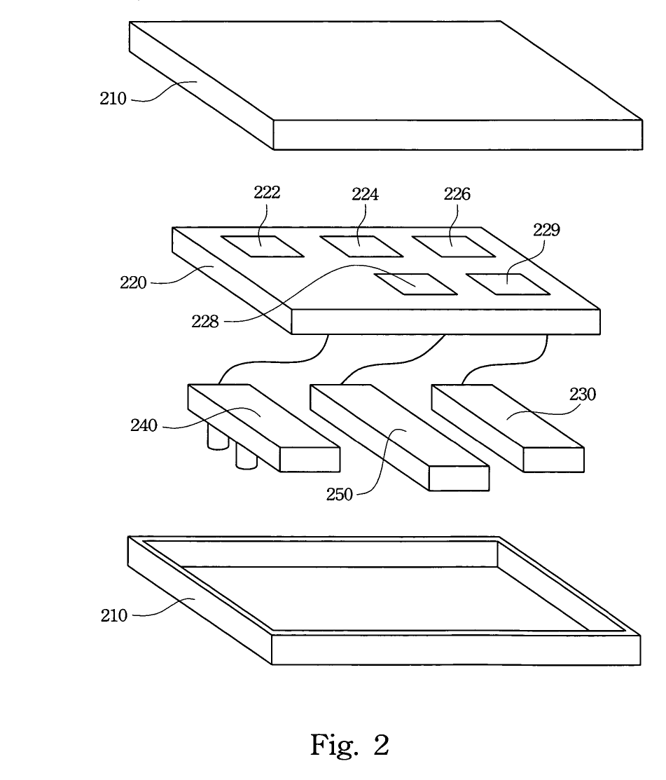

FIG. 2 is an exploded perspective view of a preferred embodiment of the module box 200. As shown, the module box 200 mainly includes a case 210, a main board 220, and a television (TV) signal receiving module 230. The main board 220 is mounted in the case 210 and electrically connected to the liquid crystal panel 120 to control the liquid crystal display 100. The TV signal receiving module 230 is mounted in the case 200 and electrically connected to the main board 220 to receive TV signals for playback on the liquid crystal display 100. In the illustrated embodiment, the TV signal receiving module 230 is independently provided and separated from the main board 220. However, it is understood the TV signal receiving module 230 may be otherwise integrated into the main board 220.

As can be seen from FIG. 2, in the module box 200, a power supply circuit 250 and a back-end audio/video (AV) input/output (I/O) interface 240 may be further mounted. The power supply circuit 250 is mounted in the case 210 and electrically connected to the main board 220 to supply power to the liquid crystal display 100. The back-end AV I/O interface 240 is also mounted in the case 210 and electrically connected to the main board 220, so as to provide the liquid crystal display 100 with an AV I/O function. Similarly, the power supply circuit 250 and the back-end AV I/O interface 240 are independently provided and separated from the main board 220 in the illustrated embodiment. However, it is understood the power supply circuit 250 and the back-end AV I/O interface 240 may be otherwise integrated into the main board 220, too.

In FIG. 2, there is an analog to digital (A-D) converter 222 mounted on the main board 220. When a received TV signal is an analog signal, it is converted into a digital signal by the A-D converter 222 for playback on the liquid crystal display 100.

The main board 220 contains an image decoding chip 224 to control the image displayed on the liquid crystal display 100, an image-interlace eliminating chip 226 to eliminate interlaced images from the liquid crystal display 100; and an automatic image reducing and enlarging chip 228 to control the reduction and enlargement of an image on the liquid crystal display 100.

In addition to the above-mentioned elements 222, 224, 226, and 228, other elements may still be applied to the liquid crystal display 100 of the present invention. For example, when necessary, a sound effect processing chip 229 may be mounted on the main board 220 to provide the liquid crystal display 100 with sound effect functions.

In the illustrated embodiment, the case 210 is preferably made of a metal material, and is more preferably an electromagnetic-shielding metal box to provide an electromagnetic shielding effect for the liquid crystal display 100.

With the above arrangements, the modular liquid crystal display according to the present invention has the following advantages:
1. All functional modules of the liquid crystal display are integrated into the module box, so that a user, a maintenance man, or a manufacturer may easily adapt the liquid crystal display to actual operational requirements simply by changing an original module box to another suitable one.
2. The module box and other parts of the liquid crystal display may be separately produced and sold to a foreign country and then locally assembled together to meet the prerequisite for preferential tariff. The separately produced module box also enable assembling in simplified procedures to reduce the manufacturing cost of the liquid crystal display.
3. The liquid crystal display may be easily adapted for use with a different local TV signal form simply by changing the module box to another one having a suitable TV signal receiving module.
4. The liquid crystal display may be easily adapted for use with a different local supply voltage simply by changing the module box to another one having a suitable power supply circuit.
5. The liquid crystal display may be conveniently maintained or repaired simply by dismounting or changing the module box.
6. Since most circuits of the liquid crystal display are mounted in the module box, the problem of electromagnetic interference is largely reduced.
7. The module box may have standardized dimensions to save research and development (R&D) and mold forming costs, and to enable upgraded production efficiency of the liquid crystal display.
8. An identification databank may be built for the module boxes, so as to improve the management of spare parts and the maintenance of the liquid crystal display for the purpose of after service.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A circuit module for mounting in a liquid crystal display, comprising:
a case;
a main board mounted in the case and electrically connected to a liquid crystal panel of the liquid crystal display to control the liquid crystal display; and
a TV signal receiving module mounted in the case and electrically connected to the main board to receive a TV signal for playback on the liquid crystal display.

2. The circuit module for mounting in a liquid crystal display as claimed in claim 1, further comprising a power supply circuit mounted in the case and electrically connected to the main board to supply power to the liquid crystal display.

3. The circuit module for mounting in a liquid crystal display as claimed in claim 1, further comprising a back-end AV I/O interface mounted in the case and electrically connected to the main board to provide an AV I/O function to the liquid crystal display.

4. The circuit module for mounting in a liquid crystal display as claimed in claim 1, wherein the main board includes an A-D converter mounted thereon, such that when the TV signal received by the TV signal receiving module is an analog signal, the received analog signal is converted into a digital signal by the A-D converter for playback on the liquid crystal display.

5. The circuit module for mounting in a liquid crystal display as claimed in claim 1, wherein the main board includes an image decoding chip mounted thereon to control images displayed on the liquid crystal display.

6. The circuit module for mounting in a liquid crystal display as claimed in claim 1, wherein the main board includes an image-interlace eliminating chip mounted thereon to eliminate interlaced images from the liquid crystal display.

7. The circuit module for mounting in a liquid crystal display as claimed in claim 1, wherein the main board includes an automatic image reducing and enlarging chip mounted thereon to control reduction and enlargement of images displayed on the liquid crystal display.

8. The circuit module for mounting in a liquid crystal display as claimed in claim 1, wherein the main board includes a sound effect processing chip mounted thereon, so as to provide the liquid crystal display with a function of producing a sound effect.

9. The circuit module for mounting in a liquid crystal display as claimed in claim 1, wherein the case is made of a metal material.

10. The circuit module for mounting in a liquid crystal display as claimed in claim 1, wherein the case is an electromagnetic-shielding metal box.

11. A liquid crystal display, comprising:
a front frame;
a liquid crystal panel mounted to a rear side of the front frame;
a module box mounted behind and electrically connected to the liquid crystal panel, and including at least:
a case;
a main board mounted in the case and electrically connected to the liquid crystal panel to control the liquid crystal display; and
a TV signal receiving module mounted in the case and electrically connected to the main board to receive a TV signal for playback on the liquid crystal display; and
a back cover located behind the module box.

12. The liquid crystal display as claimed in claim 11, further comprising a power supply circuit mounted in the case of the module box and electrically connected to the main board to supply power to the liquid crystal display.

13. The liquid crystal display as claimed in claim 11, further comprising a back-end AV I/O interface mounted in the case and electrically connected to the main board of the module box to provide an AV I/O function to the liquid crystal display.

14. The liquid crystal display as claimed in claim 11, wherein the main board includes an A-D converter mounted thereon, such that when the TV signal received by the TV signal receiving module is an analog signal, the received analog signal is converted into a digital signal by the A-D converter for playback on the liquid crystal display.

15. The liquid crystal display as claimed in claim 11, wherein the main board includes an image decoding chip mounted thereon to control images displayed on the liquid crystal display.

16. The liquid crystal display as claimed in claim 11, wherein the main board includes an image-interlace eliminating chip mounted thereon for eliminating interlaced images from the liquid crystal display.

17. The liquid crystal display as claimed in claim 11, wherein the main board includes an automatic image reducing and enlarging chip mounted thereon to control reduction and enlargement of images on the liquid crystal display.

18. The liquid crystal display as claimed in claim 11, wherein the main board includes a sound effect processing chip mounted thereon, so as to provide the liquid crystal display with a function of producing a sound effect.

19. The liquid crystal display as claimed in claim 11, wherein the case is made of a metal material.

20. The liquid crystal display as claimed in claim 11, wherein the case is an electromagnetic-shielding metal box.
